(19) United States
(12) Patent Application Publication
(10) Pub. No.: US 2007/0271367 A1
(43) Pub. Date: Nov. 22, 2007

(54) Systems and methods for location-based social web interaction and instant messaging system

(76) Inventors: Zohar Yardeni, New York, NY (US); John Londono, New York, NY (US)

Correspondence Address: KAPLAN GILMAN GIBSON & DERNIER L.L.P., 900 ROUTE 9 NORTH, WOODBRIDGE, NJ, 07095, US

(21) Appl. No.: 11/796,304

(22) Filed: Apr. 27, 2007

Related U.S. Application Data
(60) Provisional application No. 60/799,136, filed on May 9, 2006.

(51) Int. Cl. G06F 15/16; G06F 15/173

(52) U.S. Cl. 709/223; 709/206

(57) ABSTRACT

Systems and methods for location-based social web interaction and instant messaging are provided. A system according to the invention may be configured to detect a plurality of instant messaging (IM) users, display a map on a graphical user interface (GUI), and display a plurality of visual indicators on the GUI. The plurality of visual indicators may represent at least a portion of the IM users. The portion of IM users may be located somewhere on the area defined by the displayed map.

### CROSS-REFERENCE TO RELATED APPLICATION

This application claims priority from U.S. Provisional Patent Application 60/799,136, filed May 9, 2006.

### BACKGROUND OF THE INVENTION

The invention relates to a system that provides web service relating to Instant Messaging (IM). Specifically, the invention relates to location-based services as they relate to IM.

IM is new method of communication affecting social norms. As such, IM impacts society in a substantial fashion.

In order to make IM more relevant to a greater portion of society, it would be desirable to expand the services to which IM relates.

It would be even more desirable to add an aspect to IM that allows IM to bridge the gap between a communications platform and a social interactive tool.

It would be yet further desirable to provide a location based system that includes features relating to finding friends and “surfing”—i.e., trying to locate friends using the Internet or other suitable system—for friends on a map.

### SUMMARY OF THE INVENTION

It is an object of the invention to expand the services to which IM relates. It is a further object of the invention to add an aspect to IM that allows IM to bridge the gap between a communications platform and a social interactive tool.

It is a yet further object to provide a location based system that includes features relating to finding friends and “surfing”—i.e., trying to locate friends using the Internet or other suitable system—for friends on a map.

A method according to the invention may include displaying a navigable map on a graphical user interface (GUI) and displaying a group of images on the GUI. Each of the images may be associated with an instant messaging (IM) user that is located within an area that corresponds to the area displayed on the navigable map.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows a graphical user interface (GUI) according to the invention;

FIG. 2 shows a friends list according to the invention;

FIG. 3 shows a messaging window according to the invention;

FIG. 4 shows a filter interface and a favorites interface according to the invention;

FIG. 5 shows a settings interface according to the invention;

FIG. 6 shows a photo interface according to the invention;

FIG. 7 shows another graphical user interface (GUI) according to the invention; and

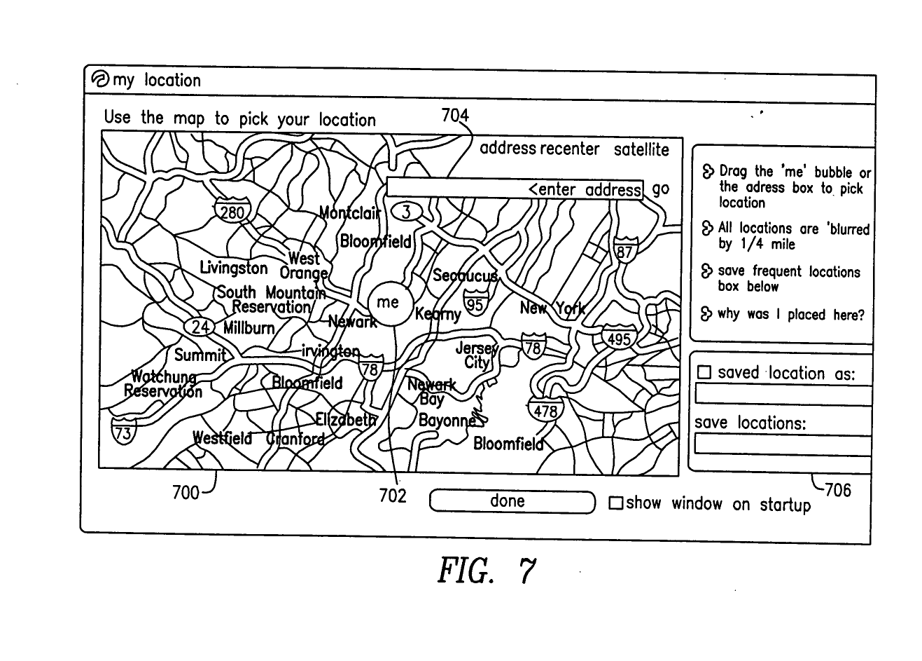

FIG. 8 shows a block diagram of an architecture according to the invention.

### DETAILED DESCRIPTION OF THE INVENTION

Systems and methods according to the invention enable users to see where their friends are located and also to navigate a map in order to see where other users on the system are located. The systems and methods also preferably allow for users to Instant Message (IM) their respective friends, acquaintances and IM partners, or any other suitable party or IM user.

In one exemplary embodiment of the invention, the system may show the location of selected users (IM users or other non-IM system users) on a map. The system may further display around the map still images (or, in an alternative embodiment, video clips which may or may not include audio capability) of users that are physically located somewhere within the map (“Locals” as defined herein. For the purposes of this application, Locals are users that are physically located somewhere within the user map and are not currently in the Friends list on the existing system platform(s)). These images may be enlarged (or the movies may be played) when a pointer associated with a mouse is dragged over the images. The specific location of the users may be determined preferably only within a pre-determined tolerance. It should be noted that the application according to the inventions may be accessed from PC's, mobile devices, handheld PDAs, mobile phones, and other suitable electronic device.

In one exemplary embodiment of the invention, a college student may use the system in order to see which friends are on campus and which have gone home. Typically, the systems and methods according to the invention enable users to see the location of other users who are currently using a system according to the invention which may be IM-based or may be independent of IM.

In other embodiments of the invention, another user may login to check out other participants on the system according to the invention (which may or may not require use of IM) in the user's neighborhood. In yet another embodiment, an employer can use the system to determine how many of the employees are presently “on site”, what percentage of the employees have gone home, are out to lunch, or not on site for any other reason etc. In yet other embodiments of the invention, the presence and or absence of users may be monitored by an Application Programming Interface (API) that may aggregate the location data and provide or transmit the location data to a suitable location and/or destination.

Moving, zooming in, and zooming out the map may bring up a new group of people Local to the area delineated by the map. This enables any user to “browse” or “surf” for new people by location.

In one embodiment of the invention, users can filter Locals. Such filters may limit the Locals to those Locals that have some relationship with the user. In another embodiment of the invention, the system may provide the user with a list of filter parameters from which the user can select a suitable filter parameter or parameters by which to filter which locals appear on the user's map.

In one embodiment of the invention, a user can contact a Local by selecting and/or clicking their picture to message them or right clicking to see additional communications' options. The options may include an option to display the Local's profile or add them as a friend.

In another embodiment of the invention, selected “favorite” Locals and recently-contacted Locals can be displayed by clicking a “favorites” button. Favorite Locals may be system users that the user decided to store or bookmark so they can quickly and easily contact them. Recent Locals may be those users that the user recently messaged with or viewed their profile.

In addition to the location-based service that the system according to the invention provides, the system may also enable core instant messaging functionality. In this embodiment of the invention, the inventive system operates its own IM network which preferably enables all network users to IM each other. Features of the IM network according to the invention may be based upon the known practices established by the large IM providers and may include: message logging, custom and standard away messages, offline message support, visual and audio message notification, groups, and blocking functionality.

Users can also message friends on AOL, ICQ, MSN, Yahoo, Google Talk and any Jabber service using the system according to the invention. Preferably, the system according to the invention supports friend additions, blocking, and other features on these third party networks. Users can also choose to save account information for AOL, ICQ, MSN, Yahoo, Google Talk and Jabber in order to speed up the login process. These passwords may be encrypted both on the system servers and in the user's browser using 1024-bit RSA keys.

Existing friends in other networks may show up on the Friends list and as icons on the map according to the invention. Friends can be added directly or invited via e-mail. Any system user can invite any other user to be a friend by right clicking them or by some other suitable method. Additionally, users can choose to share their respective Friends list in the system according to the invention with existing friends. This “Friend of Friend” functionality is a social networking feature.

In one embodiment of the invention users are able to create and edit rich profiles. A photo editor according to the invention allows multiple photos to be uploaded, zoomed, and panned. In other embodiments, the profiles may contain audio and video clips of the users. In view of the foregoing, a system according to the invention may include other social networking profile features such as leaving comments for users, rating user profiles and photos, adding testimonials, and introducing blogging functionality.

In one embodiment of the invention, users may self-define their respective locations on the map according to the invention. Alternatively, the system may determine the position of the user based on known location system. The system may determine—i.e., auto-position—the location of the user using technologies which are described in more detail.

Users may also store favorite locations by clicking on a map or entering an address. Users can hide their location from a friend by simply right-clicking (or otherwise selecting) that friend and selecting the “hide my location” setting. To hide location from a Local, users can block that Local. This Local will no longer be able to see or detect whether the user is online and, consequently, the user's location will be automatically hidden.

One embodiment of the system according to the invention utilizes the AJAX framework to deliver desktop-like features in a web page requiring no downloads. These features of the invention may include:
Draggable and resizable windows—i.e., a substantially fully customizable layout
images that zoom in, or audios and/or videos that play, when moused over
Right click functionality
A live messaging window
A rich photo editor

The system may include a downloadable Desktop Notifier application that alerts users to new IMs with a small bubble message in their Windows system in a way that is similar to the feature as found in popular e-mail programs, such as Microsoft Outlook ™. It can also automatically launch the system when a user starts up his or her Windows personal computer.

A system according to the invention also includes privacy protection features. Addresses are preferably never stored on the system and all locations may be “blurred” to within a quarter mile or some other predetermined distance that may help to ensure participant protection. Alternatively, a user can enter an exact location into the system, if desired.

Users can additionally hide a location from specific system users by selecting “Hide My Location” option for that user. In one embodiment of the invention, Locals on the grid appear around the map, not at actual locations on the map. The map can preferably only be zoomed to ¼ mile and user locations may be continuously blurred when the map is refreshed, thus triangulation (by moving the map around) is not possible. Other suitable systems and methods for preventing unauthorized uses of the system are also within the scope of the invention. Alternatively, the system can be configured to allow a user to set the amount of location tolerances—i.e., a user can select to blur until ½ a mile, ¼ of a mile, ⅛ of a mile or some other distance, even a “no blurring” setting.

The system preferably does not verify reported locations. Thus, a user can provide inaccurate locations, without fear of detection or correction, for various reasons including privacy concerns.

To reiterate, the invention relates to a system which is a location-aware instant messaging (“IM”) rich internet application that allows messaging with other IM users and enables users to share their location with trusted friends and/or other IM users and to meet new people in their respective vicinities or in any other suitable location. The system can locate a user's friends on a map interface, and enable a user to see which Locals are physically located in a given area. In certain embodiments of the invention, only those Locals that are physically located within the map radius will show up and the interface will allow for the user to message them via an IM session. If a user zooms out, the number of Locals increase (as does the map radius).

The application preferably can be accessed via the web as a rich Internet application. In one embodiment, the system homepage allows users to login using their system user name or register for a new username. The initial login may require a registration that is verified via e-mail.

As described above, the system's core functionality is similar to the legacy IM services, with the addition of full interoperability found on services such as Trillian, GAIM, Goowy.com, and Meebo.com. System users can IM other users on like platforms. AOL, MSN, Yahoo, Jabber services, and Google Talk are typical supported legacy platforms while system users may communicate over a proprietary system network built on top of the Jabber/XMPP protocol, similar to Google Talk.

Offline messages may be supported by the system's proprietary service. Rich profiles with photo uploads may also be supported. All messages are preferably allowed to go through, but the user may be notified if the incoming message is from a Local they have no association with.

The application according to the invention also can preferably support a “friends-of-friends” or “social networking” functionality. Each system user is able to see his friend's friends by clicking a small plus-sign icon next to their name in the friend roster. In one embodiment, the system may store the history of a friend—i.e., the system may store and/or display a friend how a friend was originally introduced (from which friend's list the friend was referred, if any).

One of the system's unique location features allows a user to locate their friends on the systems' map window and meet new people who are system users or “Locals”. A friend's distance from the user can be displayed in the friend roster. The map window can display an area initially centered around the user, but can be zoomed or panned. Around the map window may be pictures of Locals (other system users) who are in this map region. A user can message these Locals and view their profiles. Once an IM session with a Local has been established, their picture may be placed in the Recent Locals list. The user then can maintain a visual log of Locals s/he has messaged with before without having to add them to the Friends list. Locals that are eventually migrated to a User's Friends roster may be removed from the Recent Locals list.

Location Privacy can be adjusted individually for each “Friend” by selecting between “Show my location” or “Hide my location”. Thus, every Friend can hide his location from a user and every user can hide his location from each Friend. For Locals (non-Friends), users can be “visible” or “invisible”; so users can be completely hidden from Locals (meaning they will not show up around anyone's map window as a Local). Locals are preferably not displayed on the map itself—only around it. Individual Locals can also be completely blocked by the user, if desired.

In certain embodiments of the invention, advertisements may be displayed in the map as icon markers in addition to the friends who are in that radius. The advertisements may be location-targeted—i.e., a restaurant may pay to advertise on screens for users that are within a pre-determined radius of the restaurant.

In one embodiment of the invention, Locals' pictures around the map become enlarged when moused-over. As a user pans or zooms, the Locals' pictures are re-populated with users in that radius. These pictures may, in one embodiment of the invention, be sorted by proximity or some other suitable metric.

In certain embodiments of the invention, the map and pictures all have a fixed aspect ratio of 4:3 even when resized. The map interface supports a full-featured Filter for filtering Locals. The Filter allows for filtering by age, sex or any other suitable filtering parameter.

The server-side pieces of an application according to the invention may include the following features:
Web servers
User logins, friends' rosters and presence processing
Determination of users on the map interface
Serves up user images & profiles
Interfacing with the interoperability solutions
Interoperability Modules
Translates message streams into appropriate protocols (Yahoo/MSN/AOL/GTalk)
Backend Data Base
System user info and profiles, Friends lists, Interop user names, images, audio/video
Jabber IM Server
E-mail/SMTP
Authentication e-mails, forgot password e-mails, administrative alerts

Users may manually report their geographical location as described above, or the system can position users automatically using a) I.P. geo-location, a process in which the user's unique IP address is resolved to a geographical location, b) wireless positioning, a process in which wireless access points or cellular towers in the vicinity of the user's wireless-enabled or cellular-enabled machine are obtained and their location is determined using an existing database of wireless access points and cellular towers, c) GPS positioning, a process in which a user's machine has the capability to position itself using Global Positioning Satellite hardware and software or any other suitable positioning system and/or method.

Embodiments of the present invention are described herein in the context of a system that provides web service that enables users to see where their friends are located and who else is located on the user's map and to Instant Message (IM) them. Those of ordinary skill in the art will realize that the detailed description of the present invention is illustrative only and is not intended to be in any way limiting. Other embodiments of the present invention will readily suggest themselves to such skilled persons having the benefit of the disclosure. Reference will now be made in detail to implementations of the present invention as illustrated in the accompanying drawings. The same reference indicators will be used throughout the drawings and the following detailed description to refer to the same or like parts.

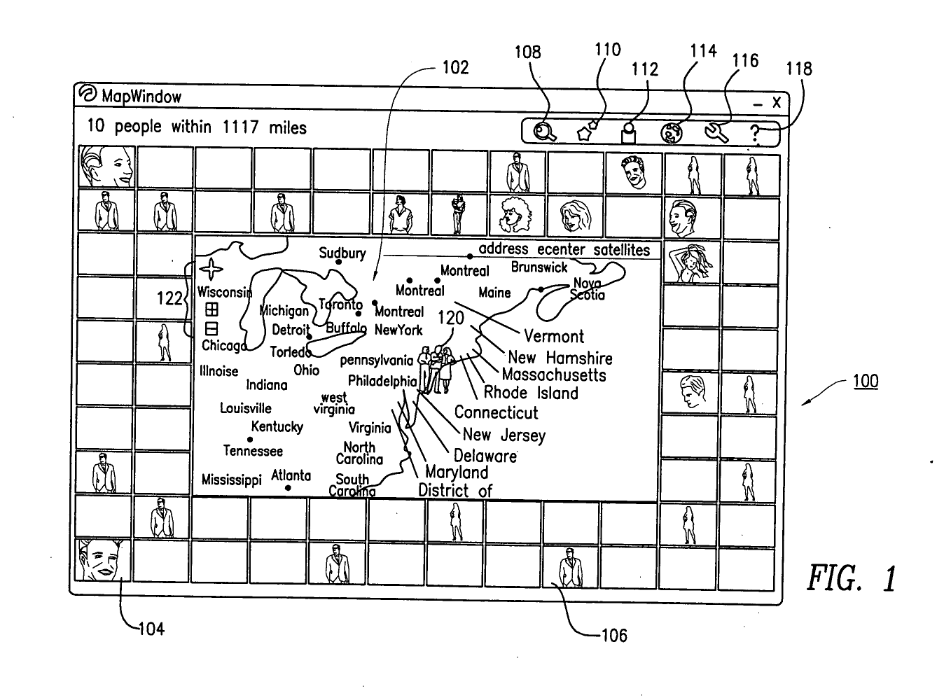

FIG. 1 shows that a graphical user interface (GUI) according to the invention may display a map 102. The system may further display around map 102 still images 104 (or, in an alternative embodiment video clips) of users that are physically located somewhere within the map (“Locals”) and, preferably, are presently using their respective IM systems. These images 104 may be enlarged when a pointer associated with a mouse is dragged over the images 104. Alternatively, generic displays of users 106 may be displayed to indicate the users are in the map area but have chosen not to post a picture, have posted a picture but chose not to associate their display with the picture, or are currently offline.

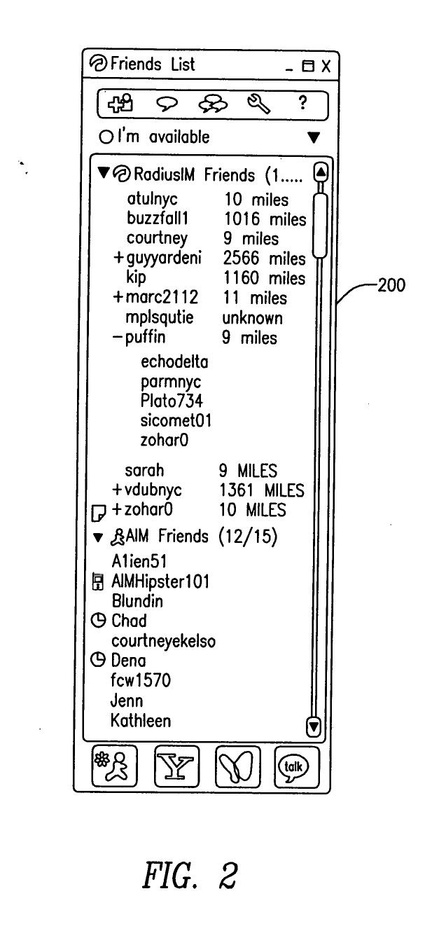

A toolbar according to the invention may include a filter tab 108, a favorites tab 110, a profile tab 112, a my location tab 114, a settings tab 116, and a help tab 118. GUI 100 may also include population indicator 120, which shows where higher concentrations of users are located, navigation pad 122 for navigating around the map as well as zooming in or zooming out, and friends list (which may be displayed together with map 102 but is shown in FIG. 2). Navigation pad turns map 100 into a navigable map because a user is able to navigate from place to place using the navigation pad and to adjust the display of the map from close in to far out. Alternatively, a user can navigate using the mouse, without the pad. The user may use the mouse to drag/pan and the mouse wheel to zoom, or may use the mouse and suitable mouse accessories in some other suitable fashion.

GUI 100 may be the main application screen that a user is presented with following user login. Map 102 preferably provides the main means for navigation and surfing for and locating people. Friends (those users that preferably have accepted invitations from a user) may show up inside the map if they are using a system according to the invention within the map and may be positioned at their current, preferably self-reported, location.

In one embodiment of the invention, other users on a network according to the invention may show up as icons around the map and are located somewhere within the map view, but a “non-friend” user—i.e., a Local as defined above—may not know where in the map the respective friends are.

As described above, moving, zooming in, and zooming out the map may bring up a new group of people Local to the newly-defined area. This enables any user to “browse” or “surf” for new people by location. A user can view another user's profile by clicking on their icon in the grid around map 100 or, in the case of a friend, by right clicking a friend and selecting the “profile” option.

In one embodiment of the invention, users can filter Locals by clicking the filter button 108. Such filters may limit the Locals displayed to Locals that have some previous relationship with the user, or by some other, preferably user-defined, parameter. In another embodiment of the invention, the system may provide the user with a list of parameters from which the user can select a suitable parameter.

FIG. 2 shows friends list 200. Friends list 200 is an instant messaging roster according to the invention. A network according to the invention preferably places radiusIM™ network users, which functions according to the invention and is based in New York, N.Y., or other suitable network users, on top. Selecting the plus sign in front of a user reveals that user's friends list. Thus, a user can view another user's friends. Note the user Puffin with her list of friends displayed below her. There is also a mileage marker to the right of each user displaying how far away the user is from the friend. Below the radiusIM network, groups are other networks that one may choose to “pipe” into the application. These networks may have the same functionality of an AOL IM, MSN or Yahoo messenger. The icons on the bottom allow a user to access the other IM networks by logging in to the other networks.

Selecting or clicking the add a friend icon on top of the Friends list allows users to add people to their friends list that already have accounts on either radius IM, or one of the other networks. Users can also send invitations to join the network according to the invention by emailing other friends. Finally, a user can import their list of contacts from one of the large email providers and invite all or some subset of these contacts to a network according to the invention.

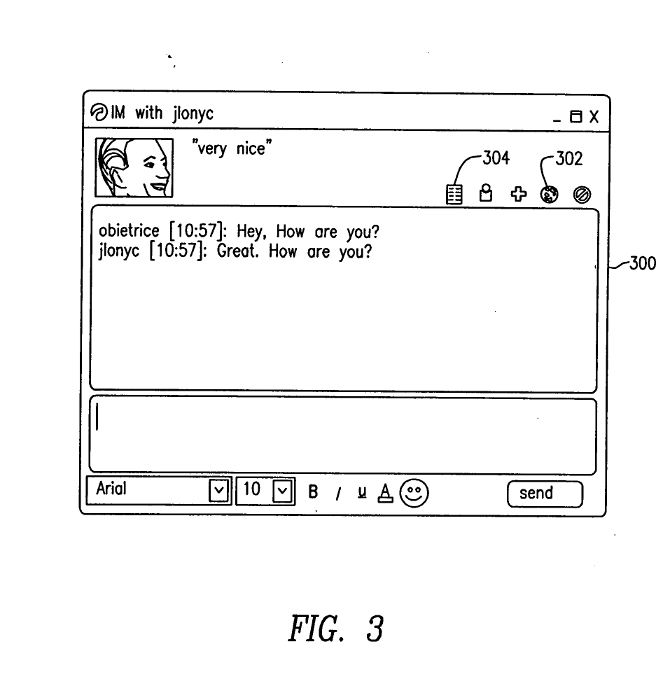

FIG. 3 shows a messaging window 300. Messaging window 300 can be used to conduct IM. One additional feature in window 300 is globe icon 302. By clicking globe icon 302, the location of the friend of the current IM session may appear on a map on the interface of the user. By clicking show log icon 304, a log of the most recent IM dialogue, or other IM dialogues, may be shown.

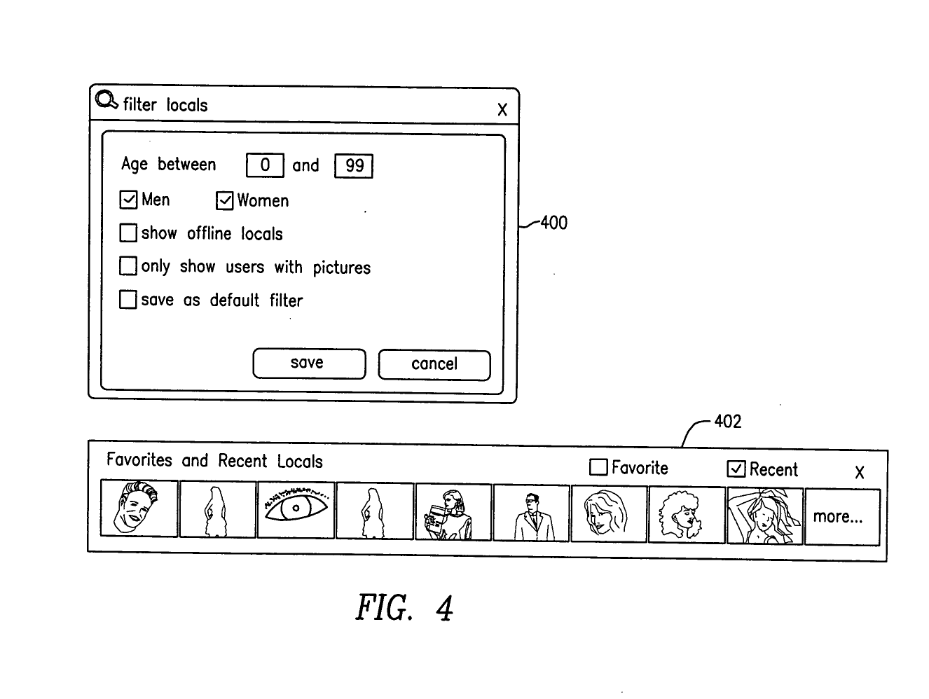

FIG. 4 shows the filter interface 400 and the favorites interface 402 that are displayed in response to a user selection of icons 108 and 110, respectively, as shown in FIG. 1. These two interfaces are not necessarily related. Filter interface 400 allows a user to filter the results set of the map grid. In this example, filter interface 400 is configured to include all men and women of all ages. Favorites interface 402 may appear below the map window and may function as a bookmarking system for the people around the map that are not listed among the friends group.

Selection of profile interface icon 112 may cause the edit profile interface to be displayed within the broader settings window.

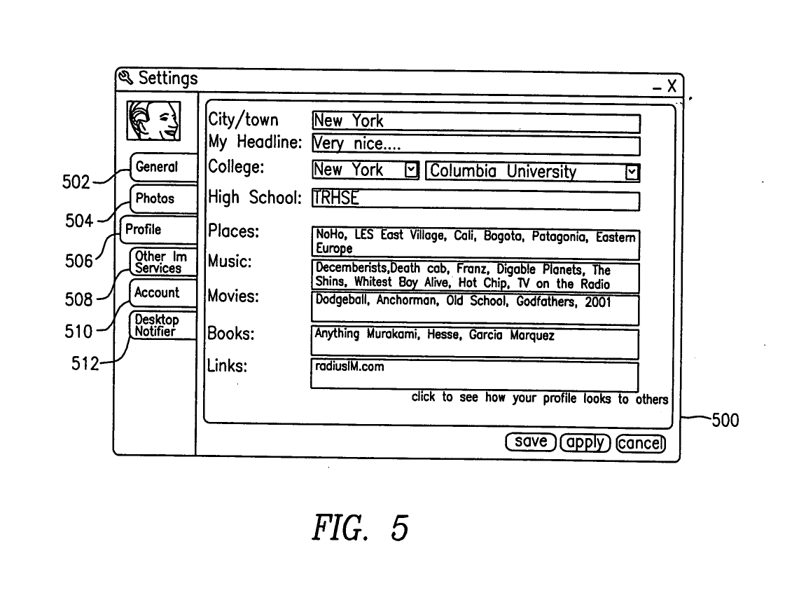

FIG. 5 shows settings interface 500 which may be displayed in response to a selection of profile icon 112 shown in FIG. 1. In order to navigate to broader settings, the interface may include tabs for general settings 502, photos 504, profile 506, other IM services 508, account 510, and desktop notifier 512. Broader settings may also be displayed in response to a selection of settings icon 118 in FIG. 1. Here the user can add and change information for his or her profile as well as edit general settings for the user experience and add login information for accessing other IM networks like AOL IM, Yahoo, MSN, Google Talk and Jabber. The account tab allows a user to change user information like first name, country, zip, email address and passwords.

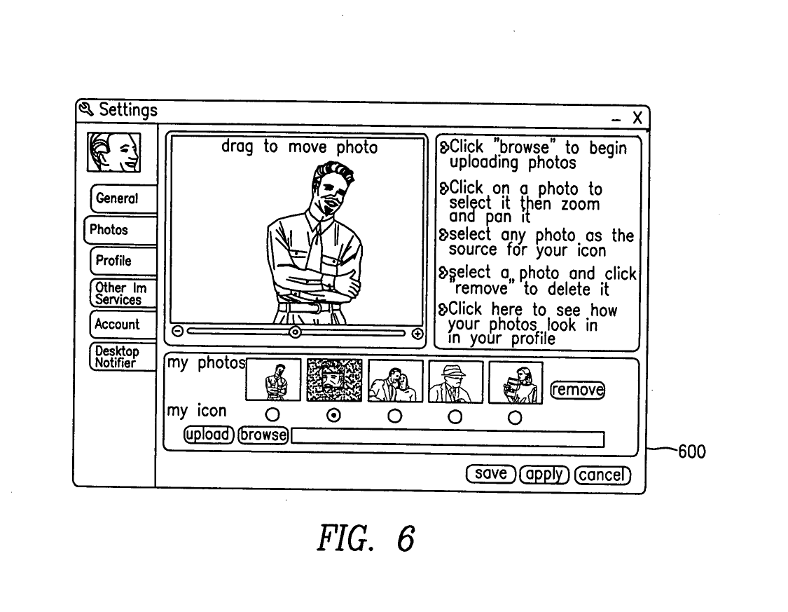

FIG. 6 shows photos interface 600 that may be obtained by selecting photos tab 504. Photos may be uploaded using photo interface 600 among other features, as shown. Photo settings may also be configured to allow a user to include the photos in his profile. Furthermore, the system can allow the user to zoom in, out and select the area to be highlighted for the photos in his profile.

Location icon 114 preferably causes a more detailed map 700, which may form part of a location reporting interface, to be displayed. Map 700 may preset a user location to a particular area as described above. The user may more particularly define his location using location ball 702, or by filling in address field 704. The system may also provide saved location field 706 which is adapted to provide an input field for a user to save and store common, favorite or any other type of addresses such as home, work, or school.

More specifically, in this map, it has been shown that a user can self-report—i.e., self-define—his location. In one method according to the invention, a user can simply drag location ball 702 to a location of his choice. Location ball 702 also demonstrates that, in one embodiment of the invention, a “blurring” of the location may indicate that, preferably, a user can be located only to an accuracy of about ¼ of a mile or some other predetermined distance.

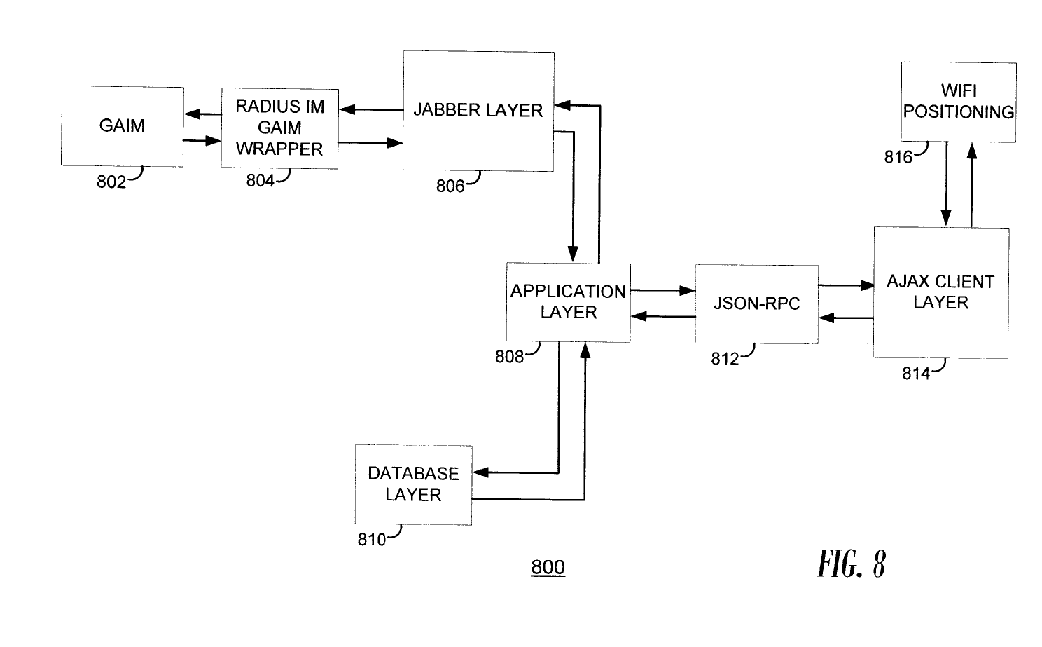

FIG. 8 shows a block diagram of an exemplary architecture 800 according to the invention. GAIM block 802 is an open source project providing a desktop client application for connecting to multiple IM networks. The system according to the invention may tap into this functionality through a wrapper program 804. Wrapper program 804 may communicate with Jabber layer 806. Jabber layer 806 may provide a core messaging infrastructure handling preferably all incoming and outgoing instant messages. As is known in the art, Ejabberd is a known open source messaging server running the Jabber open standard protocol.

Application layer 808 houses preferably all the business rules and serves as a gatekeeper for messaging traffic. This layer may preferably be written in Java and communicates to the AJAX client layer 814 through JSON RPC 812. Database layer 810 preferably includes database architecture housing user data and all supporting information for enabling a robust location based messaging architecture. JSON RPC 812 may be any suitable middleware layer linking the client side JavaScript application in the server side Java application layer.

AJAX client layer 814 (in this application, the AJAX client layer may include any of the GUIs disclosed herein) is typically a single page AJAX (Asynchronous JavaScript and XML) website providing a proprietary location based instant messaging network. Additionally, users can preferably access their AOL IM, ICQ, Yahoo, MSN, Google Talk and/or Jabber IM accounts all in one application accessible from any browser with Internet connectivity.

Finally, WiFi positioning 816 may be a plugin to the AJAX application allowing for the website to report on visible WiFi networks and triangulate a location based on a preferably geocoded WiFi access point database.

The above are exemplary modes of carrying out the invention and are not intended to be limiting.

Thus, systems and methods for location-based social web interaction and instant messaging system have been provided. Persons skilled in the art will appreciate that the present invention can be practiced by other than the described embodiments, which are presented for purposes of illustration rather than of limitation, and the present invention is limited only by the claims which follow.

What is claimed is:

1. A graphical user interface (GUI) that displays:
a navigable map; and
a group of visual indications that indicate the presence of instant messaging users that are located within an area corresponding to the navigable map.

2. The GUI of claim 1 further comprising a second navigable map that displays a location of a user, said second navigable map that is accessible from said navigable map.

3. The GUI of claim 2, the second navigable map that displays user location in response to a user instruction.

4. The GUI of claim 2, the second navigable map that displays user location in response to a system determination.

5. The GUI of claim 1, the navigable map that further comprises a navigation pad, said navigation pad that is adapted to receive instructions to change map position, to zoom in on said map, or to zoom out on said map.

6. The GUI of claim 1, wherein the instant messaging users are classified according to a predetermined hierarchy.

7. The GUI of claim 6, wherein the instant messaging users are classified according to a system-set hierarchy.

8. The GUI of claim 6, wherein the instant messaging users are classified according to a user-defined hierarchy.

9. The GUI of claim 1, further comprising a second navigable map that pre-sets the location of a user based on the user's IM activity, displays a location of a user, and is adapted to receive user instructions to further define the user's location.

10. The GUI of claim 1, further comprising a second navigable map that pre-sets the location of a user based on one of I.P. geo-location, wireless positioning, and GPS positioning.

11. The GUI of claim 1, further comprising a second navigable map that receives user instructions to define the user's location.

12. A mobile computing device comprising the GUI of claim 1.

13. The GUI of claim 1 further comprising location-targeted advertising that corresponds to a location that is located in an area corresponding to the navigable map.

14. A method comprising:
displaying a navigable map on a graphical user interface (GUI); and
displaying a group of images on the GUI, each of the images that is associated with an instant messaging (IM) user that is located within the navigable map.

15. The method of claim 14 further comprising displaying each of the images when the respective IM user is currently active on his IM system.

16. The method of claim 14 further comprising displaying each of the images when the respective IM user is registered with the same network as the network in which the GUI is displayed.

17. The method of claim 14 further comprising displaying at least a portion of the images in a position on a map that corresponds to the location of the IM user.

18. The method of claim 14 further comprising displaying at least a portion of the images in a position on a map that corresponds to a self-defined position of each of the IM users.

19. The method of claim 14 further comprising displaying a second navigable map that shows a location of a user, said second navigable map that is accessible from said navigable map.

20. The method of claim 19, further comprising displaying the user location on the second navigable map in response to a user instruction.

21. The method of claim 19, further comprising displaying the user location on the second navigable map in response to a system determination.

22. The method of claim 14, further comprising receiving instructions to change map position, to zoom in on said map, or to zoom out on said map.

23. The method of claim 14, further comprising classifying the users according to a predetermined hierarchy.

24. The method of claim 14, further comprising pre-setting the location of a user, displaying a location of a user in response to said pre-setting, and receiving user instructions to further define the user's location.

25. The method of claim 14, further comprising displaying location-targeted advertising on the GUI, said location-targeted advertising corresponding to a location that is located in an area corresponding to the navigable map.

26. A location-based instant messaging network comprising:
a core messaging infrastructure that handles incoming and outgoing instant messages;
an application layer that houses system business rules and that provides gatekeeper functions for messaging traffic and that communicates to an asynchronous javascript and XML (AJAX) client layer;
a middleware layer that links a client side JavaScript application and the application layer; and
a database layer that houses user data and supporting information and that enables a location-based messaging architecture.

27. The network of claim 26 wherein the application layer is written in Javascript.

28. The network of claim 26 further comprising an AJAX client layer that provides a location-based instant messaging network.

29. The network of claim 26 further comprising an application for connecting to a plurality of IM networks.

30. The network of claim 29 wherein the system may connect to the plurality of IM networks using a wrapper program.

31. The network of claim 26 further comprising a WiFi position plugin to the AJAX client layer.

32. A system configured to:
detect a plurality of instant messaging (IM) users;
display a map on a graphical user interface (GUI); and
display a plurality of visual indicators on the GUI, said plurality of visual indicators corresponding to at least a portion of the IM users, each of the IM users in the portion that are identified by the system as being located on the displayed map.

33. The system of claim 32 further configured to classify the users with respect to a single user according to a predetermined hierarchy.

34. The system of claim 32 further configured to receive self-reported location information from the IM users.

35. The system of claim 32 further configured to provide a second graphical user interface (GUI) that is adapted to receive IM user location information.

36. The system of claim 32 further configured to classify the users according to a predetermined hierarchy.

37. The system of claim 36 wherein the respective location of each of a first group of users is displayed on said map and a respective location of each of a second group of users is not displayed on said map, said plurality of said IM users being divided into said first group of users and said second group of users at least in part according to said hierarchy.

38. A mobile computing device comprising the system of claim 32.

39. The system of claim 32 further configured to display location-targeted advertising on the GUI, said location-targeted advertising corresponding to a location that is located in an area corresponding to the navigable map.

40. A system configured to:
detect a plurality of system users;
display a map on a graphical user interface (GUI); and
display a plurality of visual indicators on the GUI, said plurality of visual indicators corresponding to at least a portion of the users, each of the users in the portion that are identified by the system as being located on the displayed map.

41. The system of claim 40 further configured to classify the users with respect to a single user according to a predetermined hierarchy.

42. The system of claim 40 further configured to receive self-reported location information from the system users.

43. The system of claim 40 further configured to provide a second graphical user interface (GUI) that is adapted to receive user location information.

44. The system of claim 40 further configured to classify the users according to a predetermined hierarchy.

45. The system of claim 44 wherein the respective location of each of a first group of users is displayed on said map and a respective location of each of a second group of users is not displayed on said map, said plurality of said users being divided into said first group of users and said second group of users at least in part according to said hierarchy.

46. A mobile computing device comprising the system of claim 40.

47. The system of claim 40 further configured to display location-targeted advertising on the GUI, said location-targeted advertising corresponding to a location that is located in an area within the navigable map.
